(19) United States
(12) Patent Application Publication
(10) Pub. No.: US 2005/0163595 A1
(43) Pub. Date: Jul. 28, 2005

(54) Clamping method with improve bolt refention

(76) Inventor: Ron Morris, Valley Spring, AR (US)

Correspondence Address: RICHARD J. POE, 391 Hwy 286 E, Conway, AR, 72032, US

(21) Appl. No.: 10/765,224

(22) Filed: Jan. 26, 2004

(51) Int. Cl. F16B 35/00

(52) U.S. Cl. 411/395

(57) ABSTRACT

A method for retaining a screen clamping rail with bolts having non-round portions between the bolt heads and the threaded portions of the bolts, such as carriage bolts, where such portions between bolt heads and threads are square. The improvement over the prior art being the addition of retainer devices at the junction of the threaded portion and the non-round portions of the bolts after the bolts have been passed through non-round holes of like shape and size in the screen clamping rail. This facilitates the installation of the assembly of screen clamping rail, bolts, and retainers into the media separating shaker machine to clamp the shaker screens against the side of the machine without having the bolts either back out completely or back out far enough so that the non-round portions become disengaged allowing the bolts to rotate while attempting to install and tighten, or loosen, nuts onto the bolt threads from outside the shaker machine. While this method offers much ease of installation and disassembly to the field of art of media separating shaker machinery, it is applicable in any assembly where the heads of bolts cannot be easily held with a wrench or where carriage bolts or bolts with other non-round engagements portions cannot be positively maintained in engagement with like non-round holes while assembly or disassembly is in progress.

### BACKGROUND OF THE INVENTION

1. Field of the Invention

This invention was conceived as an improvement over prior art methods employed in the clamping and unclamping of shaker screens in media separating shaker machines. However, it will be evident that the present invention has broader applications where it is beneficial to prevent bolts from rotating while tightening and loosening nuts installed thereon.

2. Description of the Related Art

In large media separating shaker machines the media is fed into the machine which is vibrating under power to move the media such as gravel of various sizes over stacked tears of screens, each screen having a progressively smaller mesh spacing than that above. The vibrations or shaking action of the machine causes a separation of the media into groups by size. The shaker screens must from time to time be removed from the machine for maintenance and cleaning. To facilitate the removal and installation of the shaker screens they are fashioned having sides with edges at the top of the sides turned inward. A clamping rail with a “C”, “U”, or channel shaped cross section is used to engage the inward turned top edges on each side of the shaker screens. The clamping rail has holes along its length for receiving bolts through it and through holes in the side of the machine so nuts can be installed on the bolts from the outside and tightened to draw the clamping rail into fast engagement with the top edge of the shaker screen and the inside wall of the machine.

In most cases of the prior art the bolts used to secure the clamping rail to the screen and the machine are standard type carriage bolts. The clamping rail has a series of square holes along its length to receive the carriage bolts. Carriage bolts are used because the space between the screens inside the machine does not permit a bolt with a hex or other type head to be reached with a wrench. Also, a hex or other type head would be eroded by abrasive action from contact with the media to the point that a wrench would not hold it while loosening the nuts from the outside. Another significant problem with the prior art is that the space limitations require that the clamping rail be maneuvered into position from outside the machine from one end with all the bolts inserted in the clamping rail. In such a semi-blind and tedious operation it is near impossible to keep some of the bolts from backing out and falling into the machine and become lost in the media.

In one attempt of the prior art the bolts use are of special design. The bolts have no threads and the end opposite the bolt head has a slot lengthwise for receiving a wedge. The wedge avoids the issue with the bolts rotating when the nuts are rotated but it incurs a problem of its own in that the vibration of the machine loosens the wedges.

### SUMMARY OF THE INVENTION

The present invention solves the problem of bolts rotating when the nuts on the outside are turned. It also solves the problem of bolts falling out when installing the clamping rail or when removing it. This invention gives a method of retaining the bolts in the clamping rail such that the non-round section, or square section in the case of a conventional carriage bolt, stays in engagement with the non-round, or square holes, during the total operation of installing or removing the clamping rail from the machine.

The inventive methods for retaining the non-round, or square, portion of the bolts in the non-round, or square holes in the clamping rail include adding a cross-hole in the bolt in or near the junction of the threaded portion of the bolt and the non-round, or square, portion. The bolts are passed through the clamping rail so that engagement is made by the non-round portion of the bolts with the non-round holes in the clamping rail and pins are inserted into the cross-holes so as to hold the engagement while rotating nuts on or off the bolts thus preventing rotation of the bolts. Alternatively, instead of a cross-hole in the bolt, a groove can be used at or near the junction of the threaded portion of the bolt and the non-round, or square, portion. Then when the bolts are passed through the clamping rail an engagement is made by the non-round portion of the bolts with the non-round holes in the clamping rail, clips or clip rings are inserted over the groove to hold the engagement while rotating nuts on or off the bolts with the bolts being prevented from rotating.

Another alternative method is to use a retention device that has an internal opening that deforms as the device is passed onto the bolt so that it will not slide back, thus holding the non-round portions engaged. An example would be the use of an internal tooth washer that has teeth that deflect back as the washer is force onto the bolt threads. Likewise one could use an arched speed nut or other push type nut to accomplish this method.

In cases where space allows, standard hex nuts can serve the purpose of holding the non-round portions in engagement by threading them onto the bolts against the non-round portion after the bolts have been passed through the first member or rail. Then with the bolts thus retained in this first member or rail they can be passed through the second member or machine frame en bloc so a second set of nuts can be threaded on the bolts from the outside and made tight. However, in a vibration environment the inner retainer nuts tend to shake loose with their purpose being defeated.

This specification defines and claims the subject matter of the invention. The drawings along with the description of the preferred embodiment will serve to assist in the understanding of the invention and its operation.

### BRIEF DISCRIPTION OF THE DRAWINGS

FIG. 1 is an end view of a media separating machine showing prior art.

FIG. 2 is a perspective view of a clamping rail and bolts of the prior art.

FIG. 3 is a side view of a carriage bolt with cross-hole added.

FIG. 4 is a section view of the preferred embodiment of the invention.

### DESCRIPTION OF THE PREFERRED EMBODIMENT

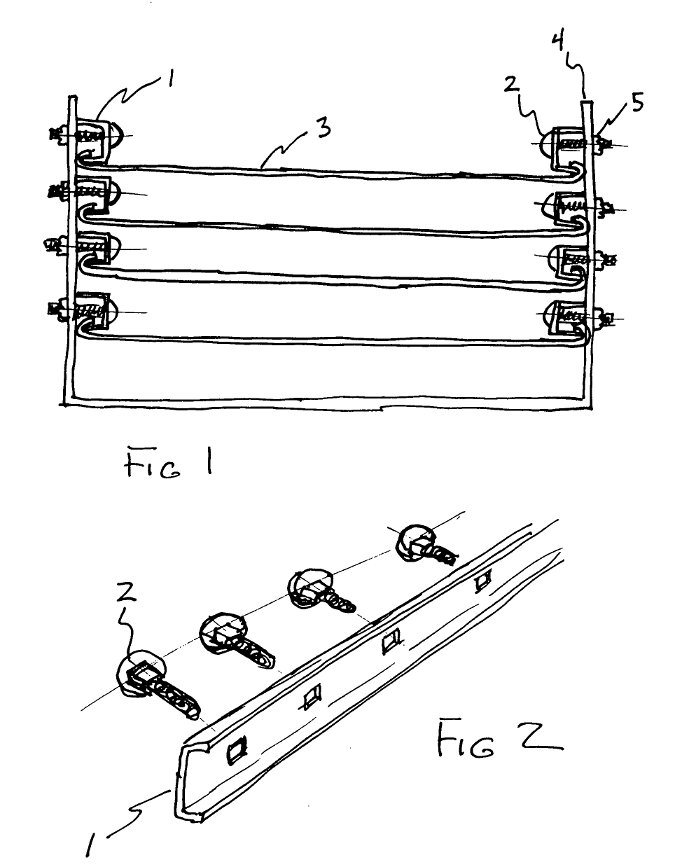

FIG. 1 is a simplified view of the end of a media separating shaker machine assembly showing clamping rail 1, carriage bolt 2, shaker screen 3, shaker machine frame 4, threaded nut 5. FIG. 1 is a depiction of the prior art.

FIG. 2 is a perspective view of the clamping rail 1 containing a series of square holes for receiving the square portion of carriage bolts 2. FIG. 2 is a depiction of the prior art.

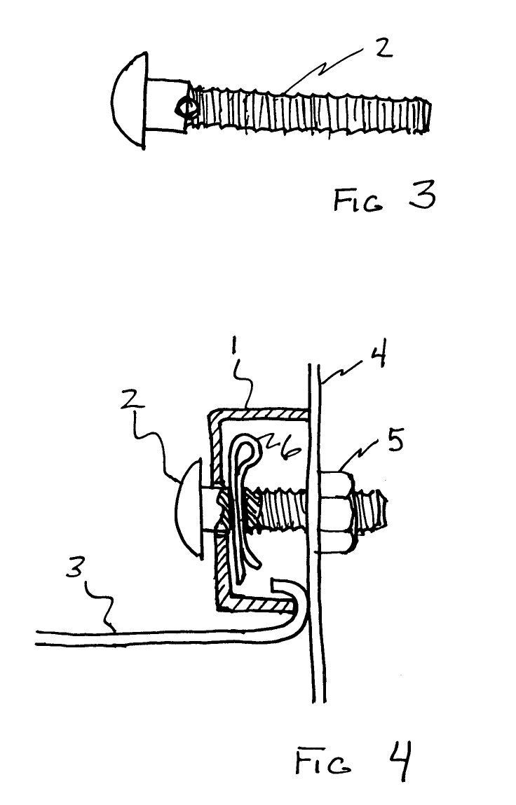

FIG. 3 is a side view of carriage bolt 2 modified by adding a cross-hole for use in the method of this invention.

FIG. 4 is a section showing assembly of the present invention with cotter key 6 inserted in the cross-hole in modified carriage bolt 2 (shown in this illustration 90 degrees out of rotation to give full view of cotter key 6).

The method of the preferred embodiment is effected by assembling modified carriage bolts 2 into clamping rail 1 and installing cotter keys 6 in the cross holes in modified carriage bolts 2 on the opposite side of clamping rail 1 from the heads of carriage bolts 2 which retains the bolts in engagement with the square portion of carriage bolts 2 in the square holes in clamping rails 1.

This assembly comprised of clamping rail 1, carriage bolts 2, and cotter keys 6 can now be maneuvered into place inside the media separating shaker machine with engagement of carriage bolts 2 effected with holes in the side of the media separating shaker machine frame 4 without carriage bolts 2 backing out and falling from clamping rail 1 because they are retained by cotter keys 6. As the assembly is positioned into place with carriage bolts 2 engaging holes in the media separating shaker machine frame 4 from the inside, the lower edge of clamping rail 1 contacts the inside curved area of shaker screen 3 and the upper edge of clamping rail 1 contacts the side of media separating shaker machine frame 4, nuts 5 can then be installed on carriage bolts 2 from the outside of media separating shaker machine frame 4 without carriage bolts 2 rotating while nuts 5 are tightened. Tightening nuts 5 causes clamping rail 1 to draw tight against shaker screen 3 keeping shaker screen 3 clamped to the side of the media separating shaker machine frame as the machine vibrates.

A major benefit of the method of this invention occurs when shaker screens 3 are to be removed from the media separating shaker machine. After use in a moist and gritty environment removing nuts 5 in prior art applications is a problem of some consequence. In the prior art nuts 5 can be loosened to a point and then the slack that results allows carriage bolts 2 to back out of square engagement.

Then nuts 5 and carriage bolts 2 rotate together preventing further loosening. Because of space limitations between shaker screens 3 there is no adequate way to reach inside and press against the heads of carriage bolts 2 to hold them in square engagement. In the present invention carriage bolts 2 are retained from backing out of square engagement in clamping rail 1 as little or no slack occurs when loosening nuts 5. Therefore, removal of the clamping rail or freeing it from clamping action by loosening nuts 5 is not hindered.

Although the best mode contemplated for carrying out this invention has been shown in the preferred embodiment, alternate approaches are disclosed and it is apparent that modifications and variations of this method may be made without departing from what is the subject matter of this invention.

1. A method of retaining a threaded bolt to prevent rotation thereof while installing a nut onto or removing a nut from said threaded bolt comprising
inserting said threaded bolt which has a section between the threaded portion and the bolt head that is non-round into a member that has an opening of like size and configuration to the non-round portion of said bolt
installing a retainer onto said threaded bolt on the opposite side of said member from the bolt head at or near the junction of the threaded portion and the non-round portion of said threaded bolt
whereby, the non-round portion of said threaded bolt is restrained from moving out of engagement with the non-round opening of said member.

2. A method as in claim 1 whereby said threaded bolt is a carriage bolt modified to receive a retainer near the junction of the threaded portion and the square portion of said carriage bolt, and said member having a square opening of like size to the square portion of said carriage bolt.

3. A method as in claim 2 where said carriage bolt is modified by adding a cross hole to receive a pin which serves to retain the square portion of said carriage bolt in the square opening of said member.

4. A method as in claim 3 where said pin inserted into the cross-hole is a roll pin.

5. A method as in claim 3 where said pin inserted into the cross-hole is a cotter key.

6. A method as in claim 2 where said carriage bolt is modified by adding a Groove at or near the junction of the threaded portion of said bolt and the square portion to receive a retaining ring or clip which serves to retain the square portion of said carriage bolt in the square opening of said member.

7. A method as in claim 2 where the square portion of said carriage bolt is retained in the square opening of said member by installing over the threads of said carriage bolt next to the square portion of said carriage bolt on the opposite side of said member from the head of said carriage bolt a device having an internal opening deforming to clamp the threads of said carriage bolt.

8. A method as in claim 7 where said device having a deforming internal opening is a internal tooth washer.

9. A method of retaining a shaker screen in a media separating shaker machine comprising
installing into said media separating shaker machine said shaker screen by clamping a rail of a length sufficient to engage a major portion of said shaker screen said clamping rail having the necessary cross-sectional configuration to give clamping action to said shaker screen and having spaced along said clamping rail holes of non-round shape to receive bolts to obtain clamping action
fastening bolts for obtaining clamping action having between the threaded portion and bolt head a portion that is non-round to match the holes in said clamping rail, said bolts further having a means for retaining the non-round portion of said bolts in the non-round portion of said clamping rail
inserting said bolts into said clamping rail and retaining said bolts so that the non-round portions remain in engagement with the nor-round holes in said clamping rail, the resulting clamping rail-bolt assembly being handable without regard to orientation with said bolts remaining in place allowing said clamping rail-bolt assembly to be maneuvered into said media separating shaker machine with said bolts engaging holes in the side of said media separating shaker machine and said clamping rail becoming positioned to clamp said shaker screen to the side of said media separating shaker machine allowing said bolts to have nuts installed on said bolts on the outside of said media separating shaker machine with said nuts being tightened to clamp or loosened to unclamp said shaker screen without said bolts moving out of engagement and rotating.

10. A method as in claim 9 wherein said bolts are carriage bolts and the holes in said clamping rail are square and of a size to match the square portion on said carriage bolts.

11. A method as in claim 9 wherein the means for retaining the non-round portion of said bolts in the non-round holes of said clamping rail is by modifying said bolts by adding a cross-hole at or near the junction of the threaded portion of said bolts and the non-round portions so as to receive a pin which serves to retain the non-round portion of said bolts in the non-round holes of said clamping rail.

12. A method as in claim 11 wherein said pin inserted into the cross-hole is a roll pin.

13. A method as in claim 11 wherein said pin inserted into the cross-hole is a cotter key.

14. A method as in claim 9 wherein said means for retaining the non-round portion of said bolts in the non-round holes of said clamping rail is by modifying said bolts by adding a groove at or near the junction of the threaded portion and the non-round portion of said bolts to receive a retaining clip or ring.

15. A method as in claim 9 wherein the non-round portion of said bolts are retained in the non-round openings in said clamping rail by installing over the threads of said bolts next to the non-round portion of said bolts on the opposite side of the clamping rail from the head of the bolts a device having an internal opening deforming to clamp against the threads of said bolts and securing said device next to said clamping rail on said bolts.

16. A method as in claim 15 where said device having deforming internal opening is an internal tooth washer.

17. A method as in claim 9 wherein said means for retaining the non-round portion of said bolts in the non-round portion of said clamping rail is a standard nut or jam nut.

18. A bolt having a head at one end with a shank of non-round cross section extending from the head along said bolt length for some distance after which the shank is round and threaded for the remaining length of said bolt with said bolt having a cross-hole at or near the junction of the non-round cross section and the round threaded portion.

19. A bolt having a head at one end with a shank of non-round cross section extending from the head along said bolt length for some distance after which the shank is round and threaded for the remaining length of said bolt and said bolt having a groove around its circumference at or near the junction of the non-round cross section and the round threaded portion.
